(19) United States
(12) Patent Application Publication
(10) Pub. No.: US 2010/0264280 A1
(43) Pub. Date: Oct. 21, 2010

(54) TABLE HEIGHT PERSONAL BAG HANGER

(76) Inventor: Yousef Zaatar, Jacksonville, FL (US)

Correspondence Address: IDEATION LAW, 8153 MIDDLE FORK WAY, JACKSONVILLE, FL, 32256, US

(21) Appl. No.: 12/426,929

(22) Filed: Apr. 20, 2009

(51) Int. Cl. F16M 11/22

(52) U.S. Cl. 248/97

(57) ABSTRACT

The present invention provides apparatus for efficiently providing a storage place for a Personal Bag proximate to the bag owner. Preferably the personal bag will remain suspended above a surface supporting the apparatus. In another aspect the apparatus may impede pilfering of the bag by limiting angles of personal bag removal.

### FIELD OF THE INVENTION

The present invention relates to a freestanding device used to hold a purse or other bag off of a floor.

### BACKGROUND

Placement of a purse in the commercial world has long been a problem. In many venues a safe and hygienic way to secure a purse in a location which remains proximate to the purse owner and also conveniently out of the way from where people would like to walk or sit, has just not been available.

Many times a purse is placed upon a floor where people need to walk, or on a chair or bench in a place that is meant for sitting. In addition, in a bathroom situation, a purse is often placed upon a floor or other surface that is filled with harmful bacteria, mold or toxins. Some studies indicate that the bottom surfaces of a purse may contain more harmful bacteria than a toilet seat. It is also not uncommon for such a purse to be placed upon a tabletop that is used to serve food, thereby exposing the table top to the harmful bacteria.

Other concerns relate to a place to store a purse while the owner is occupied with some activity, such as dining, which will deter theft of the purse while the owner is occupied with the activity. Other times, a person may be confined to a chair for a short period of time, such as during dental work, hair styling, ophthalmology exam, medical examination and the like.

All of the concerns above also relate to the growing use of backpacks by members of both sexes. What is needed is a secure and hygienic place to temporarily store a bag or purse while the owner of the bag or purse is occupied

### SUMMARY

Accordingly, the present invention provides an apparatus that includes a central beam maintained in a dimension generally vertical to the floor to a height just longer than an average purse strap or back pack strap. The central beam includes a lower portion, the lower portion is fixedly attached to the base with the central beam extending upward from the base in a generally vertical direction. The central beam additionally includes an upper portion maintained at a predefined distance from the lower portion, wherein the central beam is sufficiently rigid to support a personal bag with straps. One or more bag hangers are fixedly attached to the central beam at the upper portion, wherein each bag hanger is attached at a first point to the central beam and extends upward from the first point and outward from the central beam to an open end at an angle sufficient for gravity to move a personal bag strap looped around the bag hanger from the second point to the first point.

In some embodiments, one or more bag retainers are incorporated into or attached to the bag hangers. The bag retainers are devices, which impede surreptitious removal of a personal bag from the bag hanger and therefore deter theft of a purse or other personal bag hanging on the bag hanger.

### DESCRIPTION OF THE DRAWINGS

As presented herein, various embodiments of the present invention will be described, followed by some specific examples of various components that can be utilized to implement the embodiments. The following drawings facilitate the description of some embodiments:

FIG. 1 illustrates some embodiments of the present invention with four bag hangers and pronounced retainers.

FIG. 2 illustrates some additional embodiments with angular bag retainers according to some embodiments of the present invention.

FIG. 3 illustrates some additional embodiments with varied length bag retainers according to some embodiments of the present invention.

FIG. 4 illustrates a top down view of embodiments with varied length bag retainers according to some embodiments of the present invention.

FIG. 5 illustrates a base including flat stock.

### DETAILED DESCRIPTION

Overview

The present invention provides apparatus for securing a personal bag, such as a purse or a backpack in proximity to an owner or steward of the personal bag. In some preferred embodiments, the apparatus is at or below table height and can be moved according to a seating arrangement in a restaurant. Additional embodiments include apparatus for placement in proximity to a dental examination chair, doctor's examination table, or other location where attendance to the personal bag is a second priority to a purpose for being in the location.

Definitions

“Central Beam” as used herein refers to a rigid support structure capable of supporting one or more Personal Bags with straps.

“Personal Bag with Strap” as used herein refers herein to a purse, back pack, diaper bag, attache, computer bag or other storage bag with at least one strap for carrying the storage bag by hand or over the shoulder.

“Strap” as used herein refers to an extension from a Personal Bag which either forms a closed loop or includes a closed loop capable of being placed over a support.

### Apparatus

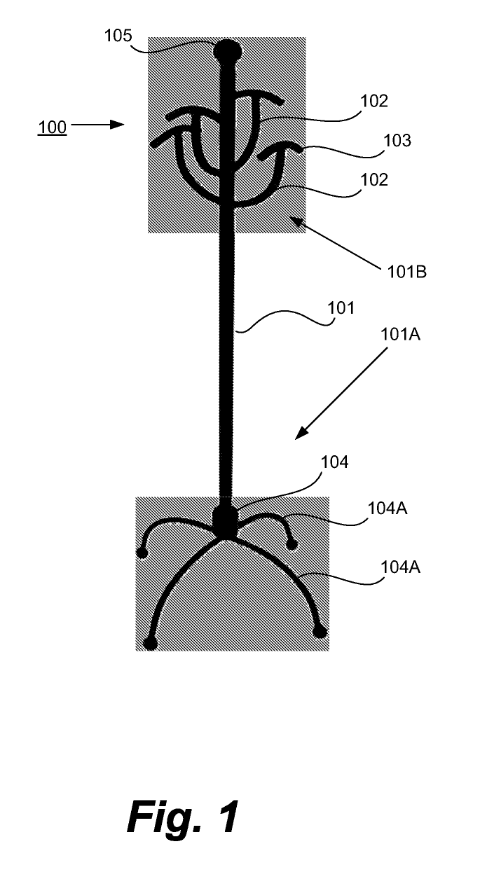

Referring to FIG. 1, a bag stand 100 is illustrated according to some preferred embodiments of the present invention. As illustrated, a central beam 101 includes a lower portion 101A and an upper portion 101B. The lower portion 101A of the central beam is fixedly attached to a base 104. The base 104 maintains the central beam in a position essentially perpendicular, or vertical, from a surface on which the base 104 rests. In some embodiments, the base 104 will include one or more legs 104A supporting the base.

The base 104 may include legs of various size, shape and number arranged to maintain the stability of the base portion 104. Alternatively, the base may comprise a solid form, such as for example: a cube, a polygon or a cylinder. The base 104 may be attached to the central beam 101 via any know means, such as, for example, one or more of: welding, threaded device, and rivets. The base 104 may also be formed in one piece with the central beam, such as, for example via cast molding. In some preferred embodiments, a combination of the base 104 and central beam 101 includes a vertical height of less than about 48 inches and preferably the height is between about 24 inches and 48 inches.

An upper portion 101B is generally distal from the base. One or more bag hangers 102 are attached to the central beam 102 at the upper portion 102B. The bag hangers include a first end and a second end. The first end is attached to the upper portion 102B of the central beam. The second end extends outward and upward from a point of attachment to the central beam 102. According to the present invention, a personal bag with a strap may have the strap placed around the bag hanger 102. The upward positioning of the bag hanger 102 will cause gravity to pull the personal bag with a strap downward and towards the central beam 101. As the personal bag with a strap comes into proximity of the central beam via the downward and inward motion, the stability of the bag stand 100 will increase due to the weight of the bag pressing downward on the beam. The close proximity of the bag to the central beam minimizes a tendency of the bag stand 100 to tip over, such as, if the force from the weight of the bag were placed at and end of the bag hanger distal to the central beam 101.

Some preferred embodiments include a bag retainer 103. The bag retainer 103 is located at an end of the bag hanger distal to the central beam 101 and includes an impediment to removing a personal bag with a strap from the bag hanger 102. In some embodiments, such as the one illustrated, a bag retainer 103 includes a crosspiece. The crosspiece 103 will typically include material of a cross shape and size similar to the bag hanger 102 set at an angle generally perpendicular to the bag hanger 102.

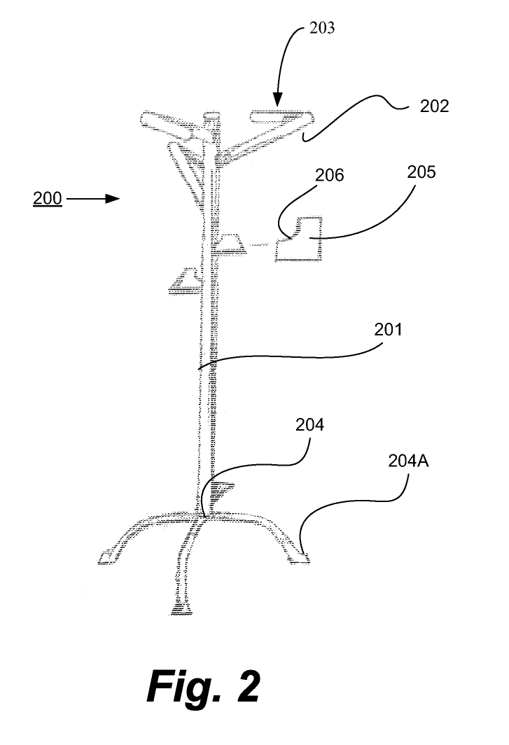

In some embodiments, the retainer 103 is a cross piece that either is curve back (as illustrated) in an arc of less than 90° from the bag hanger 102. As discussed further, below with reference to FIG. 2, additional embodiments include a straight portion angled back upon the bag hanger 102. Generally the length of a cross piece retained 103 will be less short enough to allow for a personal bag strap to be placed over the crosspiece, such as 4 inches or less, but long enough to restrain a surreptitious removal of the bag from the bag hanger 102. A curve back upon the bag hanger 103 may additionally aid with easy placement of the bag onto the bag hanger 103 and additionally impede surreptitious removal of bag from the bag hanger 103.

FIG. 1 additionally illustrates a knob 105 at the top of the central beam 101 which may act as a receptacle for hanging a short jacket or other article of clothing.

Referring now to FIG. 2, additional embodiments of a bag stand 200 according to the present invention are illustrated. The illustrated bag hangers 202 comprise essentially straight stock and include a retainer 203 that it also essentially straight stock turned back at an angle onto the bag hanger 202 of 90° or less. As illustrated, the bag retainer 103 includes a portion of the bag hanger 202 turned back onto the bag hanger 202 at an angle of 90° or less from the bag hanger 203 in a direction generally parallel to a surface upon which the bag hanger 200 rests, however other directions are also within the scope of the invention.

In some embodiments, a retainer includes fastener, such as, for example one or more of: a clasp, a hook, a hook and loop strap, a strap with a snap, one or both of a straight and bent gate carabiner, the carabiner may be with a flexible strap, such as dogbone runner to create a strong quickdraw or other fastener. The fastener can be utilized to further deter surreptitious removal of a personal bag hanging upon the bag hanger.

FIG. 2 additionally illustrates an alternate shaped bag hanger 205 attached to a central beam 201. The alternate shaped bag hanger 204 includes a polygon with an arc 206 cut through the polygon to form a curved surface to direct a bag strap placed upon the bag hanger 205 towards the central beam 201. As illustrated, the bag stand 200 additionally includes a base 204 with four legs 204A supporting the central beam in a position generally perpendicular to a surface upon which the legs 204A are placed.

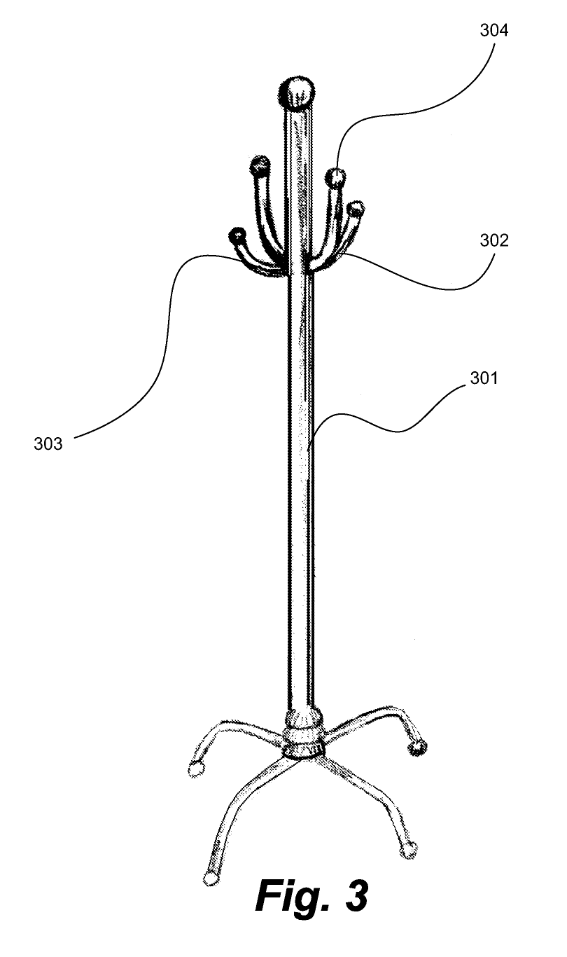

Referring now to FIG. 3, additional embodiments of the present invention are illustrated with bag hangers 302-303 of varied length and at varied arc angles to a central beam 301. The illustrated bag hangers 302-303 each additionally include a retainer 304. The retainer 304 includes a knob for impeding surreptitious removal of a bag strap placed over the bag hanger 302-303.

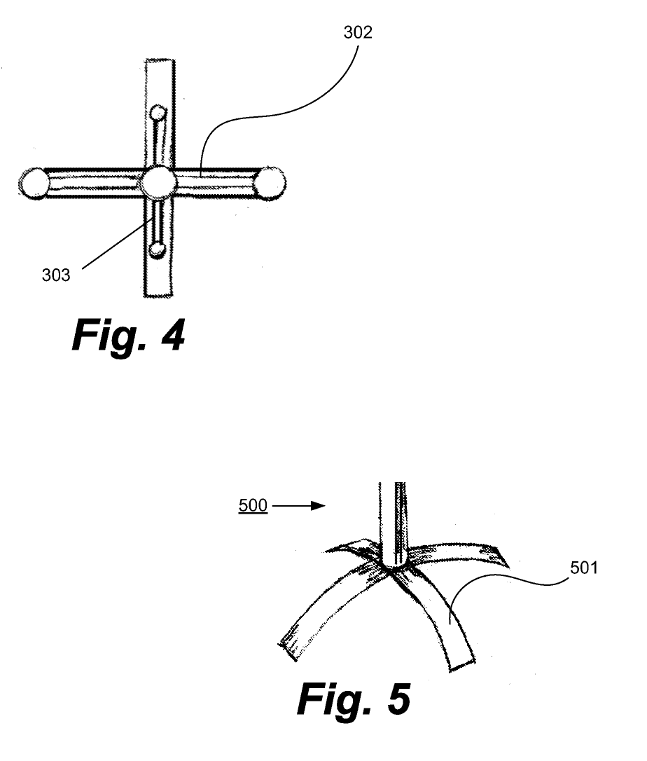

Referring now to FIG. 4, a top down view of some embodiments including bag hangers of various lengths 302-303. Referring to FIG. 5, a base 500 with flat stock legs

### Conclusion

A number of embodiments of the present invention have been described. Nevertheless, it will be understood that various modifications may be made without departing from the spirit and scope of the invention. For example, various methods or equipment may be used to implement the innovations described herein or to create a device according to the inventive concepts provided above and further described in the claims. Accordingly, other embodiments are within the scope of the following claims.

1. Apparatus for securing a personal bag with a strap, the apparatus comprising:
a base for supporting a central beam;
a central beam comprising a lower portion, the lower portion fixedly attached to the base with the central beam extending upward from the base in a generally vertical direction, the central beam additionally having an upper portion maintained at a predefined distance from the lower portion, wherein the central beam is sufficiently rigid to support a personal bag with straps and wherein the central beam extends for between 24 and 48 inches;
one or more bag hangers fixedly attached to the central beam at the upper portion, wherein each bag hanger is attached at a first point to the central beam and extends upward from the first point and outward from the central beam to an open end at an angle sufficient for gravity to move a personal bag strap looped around the bag hanger from the second point to the first point; and
a bag strap retainer portion fixedly attached to, or incorporated into the one or more bag hangers.

2. (canceled)

3. The apparatus of claim 1 wherein the bag hanger comprises a flat strap with lower portion and a upper portion and the retainer portion comprises a bend in the flat strap of more than ninety degrees between the lower portion and the upper portion.

4. The apparatus of claim 1 wherein the bag hanger comprises round stock with lower portion and a upper portion and the retainer portion comprises a bend in the round stock of more than ninety degrees between the lower portion and the upper portion.

5. The apparatus of claim 1 wherein the bag hanger comprises square stock with lower portion and a upper portion and the retainer portion comprises a bend in the square stock of more than ninety degrees between the lower portion and the upper portion.

6. The apparatus of claim 1 wherein the retainer portion comprises a knob fixedly attached to the bag hanger at the second point.

7. The apparatus of claim 6 wherein the globe comprises a diameter of about 1 inch or greater.

8. The apparatus of claim 6 wherein the globe comprises a diameter of between about 1 inch and 3 inches.

9. The apparatus of claim 1 wherein a lower portion of the bag hanger extends from the first point an angle of between about 15 degrees and 75 degrees.

10. The apparatus of claim 1 wherein a lower portion of the bag hanger extends from the first point an angle of between about 30 degrees and sixty degrees.

11. The apparatus of claim 1 wherein the bag hanger comprises an arcuate shape extending upward from the first point on the central beam.

12. The apparatus of claim 8 wherein the bag hanger comprises an arcuate shape extending upward from the first point on the central beam.

13. (canceled)

14. The apparatus of claim 1 wherein the predefined distance comprises between about 28 inches and 30 inches.

15. The apparatus of claim 1 wherein the bag hanger comprises polygon shaped material with an arc cut into the polygon for receiving a bag strap.

16. The apparatus of claim 1 additionally comprising a fastener attached to the bag hanger.

17. (canceled)

18. (canceled)
